(19) United States
(12) Patent Application Publication
(10) Pub. No.: US 2002/0194086 A1
(43) Pub. Date: Dec. 19, 2002

(54) Interaction with electronic services and markets

(75) Inventors: Siani Lynne Pearson, Bristol (GB); Jonathan Griffin, Bristol (GB)

Correspondence Address: HEWLETT-PACKARD COMPANY, Intellectual Property Administration, P.O. Box 272400, Fort Collins, CO, 80527-2400, US

(73) Assignee: HEWLETT-PACKARD COMPANY

(21) Appl. No.: 10/175,395

(22) Filed: Jun. 18, 2002

(30) Foreign Application Priority Data
Jun. 19, 2001 (GB) 0114898.0

(51) Int. Cl. G06F 17/60

(52) U.S. Cl. 705/26

(57) ABSTRACT

Apparatus and method for providing a secure environment enabling remote agents to interact with an electronic service are described. The electronic service runs in a first physically and logically protected computing environment. Each agent, acting on behalf of a respective client, runs in a separate physically and logically protected computing environment or compartment.

### FIELD OF THE INVENTION

This invention relates to interaction with electronic services and markets, and in particular to apparatus for enabling interaction of a plurality of agents with an electronic service or market.

### BACKGROUND TO THE INVENTION

With the increase in commercial activity transacted over the Internet, known as “e-commerce”, there has been much interest in the prior art on enabling data transactions between computing platforms over the Internet. However, because of the potential for fraud and manipulation of electronic data, in such proposals, fully automated transactions with distant unknown parties on a wide-spread scale as required for a fully transparent and efficient market place have so far been held back. The fundamental issue is one of trust between interacting computer platforms (and their users) for the making of such transactions.

In the applicant's co-pending International Patent Application Publication No. WO 00/48063 entitled ‘Trusted Computing Platform’, filed on Feb. 15, 2000, the entire contents of which are incorporated herein by reference, and the applicant's co-pending International Patent Application Publication No. WO 00/54125 entitled ‘Computing Apparatus and Methods of Operating Computing Apparatus’, filed on Mar. 3, 2000, there is disclosed a concept of a ‘trusted computing platform’ comprising a computing platform which has a ‘trusted component’ in the form of a built-in hardware and software component. Two computing entities each provisioned with such a trusted component may interact with each other with a high degree of ‘trust’. That is to say, where the first and second computing entities interact with each other, the security of the transaction enhanced compared to the case where no trusted component is present, because:

i) A user of a computing entity has higher confidence in the integrity and security of his/her own computer entity and in the integrity and security of the computer entity belonging to the other computing entity.

ii) Each entity is confident that the other entity is in fact the entity which it purports to be.

iii) Where one or both of the entities represent a party to a transaction, e.g. a data transfer transaction, because of the built-in trusted component, third party entities interacting with the entity have a high degree of confidence that the entity does in fact represent such a party.

iv) The trusted component increases the inherent security of the entity itself, through verification and monitoring processes implemented by the trusted component.

v) The computer entity is more likely to behave in the way it is expected to behave.

### SUMMARY OF THE INVENTION

In accordance with the present invention there is provided apparatus for enabling one or more clients to interact with an electronic service or market, the apparatus comprising a computing platform including a first logically protected computing environment within which said electronic service or market is run, and one or more second logically protected computing environments within each of which can be provided agent means for interacting with said electronic service or market on behalf of a respective client.

This can be effected by an agent being allocated initially to the client, the trustworthiness of which agent can be determined/verified by the client. Alternatively, the client can download their own agent onto a second logically protected computing environment. In either case, the problems caused by a possibly unreliable server-client connection are at least minimised because an agent is present to act on behalf of the client, thereby reducing the server-client communication which would otherwise be required.

The present invention also extends to a method of enabling one or more clients to interact with an electronic market or service, corresponding to the apparatus defined above.

In one embodiment, the client could download multiple agents, or a single agent could spawn other agents once it has been downloaded so that the client does not necessarily need to download an agent to the second logically, protected computing environment each time a service is required.

In a preferred embodiment of the present invention, communication interfaces are defined only between said agent means and a respective client and between said agent means and said electronic market or service, i.e. neither other agent means nor outside parties can communicate or interfere with another clients agent means. Further, the compartmented operating system prevents other communications from occurring. One common way of operating in practice would be for an agent or service to advertise an interface, which other agents or services connect to. In such a context the operating system (OS) (or the service itself) must be involved in preventing unwanted communications from taking place. A couple of advantages of having the OS do this are that the restrictions can't be overridden by the application/service/agent even if it is compromised and that the remote client does not have to trust the service or agent to enforce the restrictions, only the OS.

Beneficially, means are provided to verify to a client involved in a transaction or interaction with said electronic market or service that the respective agent means and the electronic market or service are operating in a trusted environment, before, during and/or after a transaction takes place. However, the client is not necessarily reported back to as part of this process. For example, the client may simply trust the agent and the agent may be arranged such that it will only allow a service to go ahead if the computing environment is satisfactory, and refuse further interaction if it is not (but not necessarily report back to the client). The main issue is that the apparatus can “prove” or provide evidence to each party involved in the transaction/interaction that their agent and the market/service are operating in a trusted software and hardware environment (and were at the time of a completed transaction.

The invention further provides computing platform programmed to support an electronic service, comprising: a first logically protected computing environment within which the electronic service runs; and two or more second logically protected computing environments each adapted to contain user agents; wherein the computing platform provides communication paths between the first logically protected computing environment and each of the two or more second logically protected computing environments, but does not provide communication paths between the two or more second logically protected computing environments.

The invention still further provides data carrier carrying a code structure to act as a user agent interacting with an electronic service running in a first logically protected computing environment of a computing platform, wherein the code structure is adapted to be installed on a second logically protected computing environment of the computing platform: the code structure being adapted to communicate with a user to receive instructions and to provide information about the electronic service, being adapted to communicate with the electronic service in the first logically protected computing environment to interact with the electronic service on behalf of the user.

### BRIEF DESCRIPTION OF THE DRAWINGS

An embodiment of the present invention will now be described by way of example only and with reference to the accompanying drawings, in which:

FIG. 1 is a diagram which partially illustrates a computing platform containing a trusted device and which is suitable for use in embodiments of the present invention;

FIG. 2 is a diagram which illustrates a motherboard including a trusted device arranged to communicate with a smart card via a smart card reader and with a group of modules;

FIG. 3 is a diagram which illustrates the trusted device in more detail; and

FIG. 4 is a schematic representation illustrating interactions between a plurality of clients and a service-provider via their respective agents.

### DETAILED DESCRIPTION OF THE INVENTION

In the following description, numerous specific details are set forth in order to provide a thorough understanding of the present invention. It will be apparent, however, to one skilled in the art, that the invention may be practised without limitation to these specific details. In other instances, well known methods and structures have not been described in detail so as to avoid unnecessarily obscuring the present invention.

Before describing a specific exemplary embodiment of the present invention, a trusted computing platform of a type generally suitable for carrying out embodiment of the present invention will be described by way of example only with reference to FIGS. 1 to 3. This description of a trusted computing platform describes the essential elements of its construction, its role in providing integrity metrics indicating the state of the computing platform to a user of that platform, and communication of such metrics to a user. A “user” in this context may be a remote user such as a remote computing entity. A trusted computing platform is further described in WO 00/48063.

A trusted platform 10 is illustrated in FIG. 1. The platform 10 includes the standard features of a keyboard 14, a mouse 16 and visual display unit (VDU) 18, which provide the physical ‘user interface’ of the platform. This embodiment of a trusted platform also contains a smart card reader 12, although this is not essential in all embodiments of the present invention. Alongside the smart card reader 12, there is illustrated a smart card 19 to allow trusted user interaction with the trusted platform (this aspect is further described in WO 00/54125). In the platform 10, there are a plurality of modules 15: these are other functional elements of the trusted platform of essentially any kind appropriate to that platform (the functional significance of such elements is not relevant to the present invention and will not be discussed further herein).

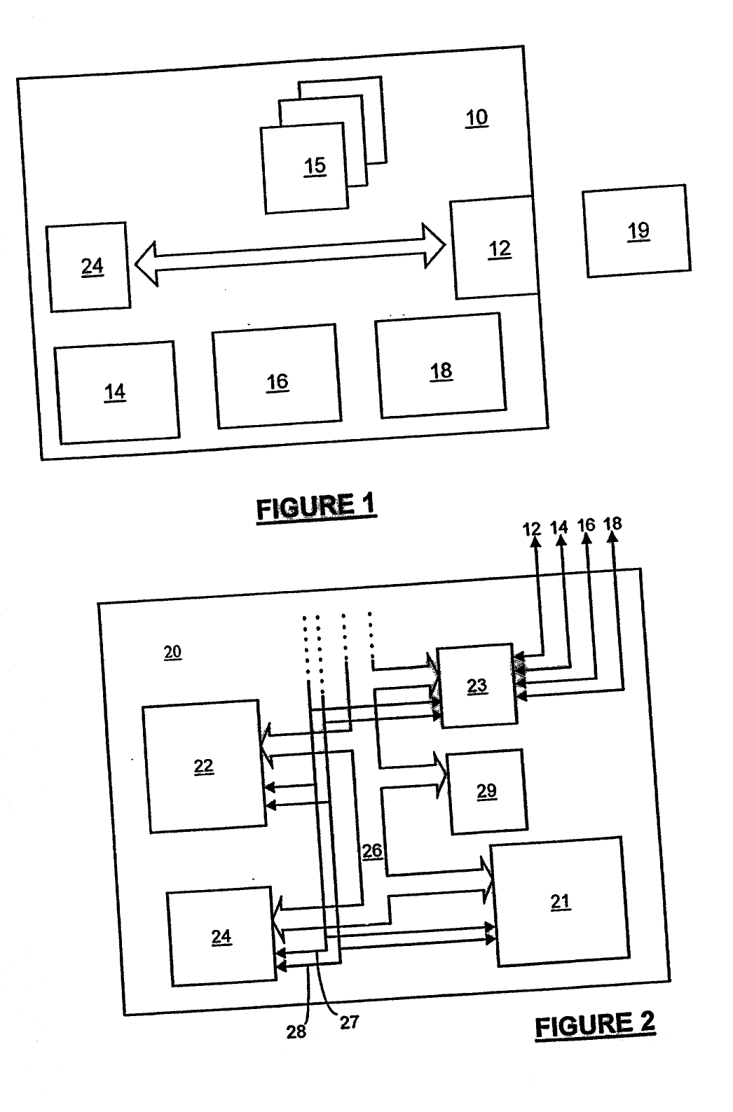

As illustrated in FIG. 2, the motherboard 20 of the trusted computing platform 10 includes (among other standard components) a main processor 21, main memory 22, a trusted device 24, a data bus 26 and respective control lines 27 and address lines 28, BIOS memory 29 containing the BIOS program for the platform 10 and an Input/Output (I/O) device 23, which controls interaction between the components of the motherboard and the smart card reader 12, the keyboard 14, the mouse 16 and the VDU 18. The main memory 22 is typically random access memory (RAM). In operation, the platform 10 loads the operating system into RAM from hard disk (not shown).

Typically, in a personal computer, the BIOS program is located in a special reserved memory area, the upper 64K of the first megabyte of the system memory (addresses F000h to FFFh), and the main processor is arranged to look at this memory location first, in accordance with an industry-wide standard.

The significant difference between the trusted platform and a conventional platform is that, after reset, the main processor is initially controlled by the trusted device, which then hands control over to the platform-specific BIOS program, which in turn initialises all input/output devices as normal. After the BIOS program has executed, control is handed over as normal by the BIOS program to an operating system program, which is typically loaded into the main memory 22 from a hard disk drive (not shown).

Clearly, this change from the normal procedure requires a modification to the implementation of the industry standard, whereby the main processor 21 is directed to address the trusted device 24 to receive its first instructions. This change may be made by simply hard-coding a different address into the main processor 21. Alternatively, the trusted device 24 may be assigned the standard BIOS program address, in which case there is no need to modify the main processor configuration.

It is highly desirable for the BIOS boot block to be contained within the trusted device 24. This prevents subversion of the obtaining of the integrity metric (which could otherwise occur if rogue software processes are present) and prevents rogue software processes creating a situation in which the BIOS (even if correct) fails to build a proper environment for the operating system.

Although in the trusted computing platform to be described, the trusted device 24 is a single, discrete component, it is envisaged that the functions of the trusted device 24 may alternatively be split into multiple devices on the motherboard, or even integrated into one or more of the existing standard devices of the platform. For example, it is feasible to integrate one or more of the functions of the trusted device into the main processor itself, provided that the functions and their communications cannot be subverted. This, however, would probably require separate leads on the processor for sole use by the trusted functions. Additionally or alternatively, although in the present invention the trusted device is a hardware device which is adapted for integration into the motherboard 20, it is anticipated that a trusted device may be implemented as a ‘removable’ device, such as a dongle, which could be attached to a platform when required. Whether the trusted device is integrated or removable is a matter of design choice. However, where the trusted device is separable, a mechanism for providing a logical binding between the trusted device and the platform is preferably present.

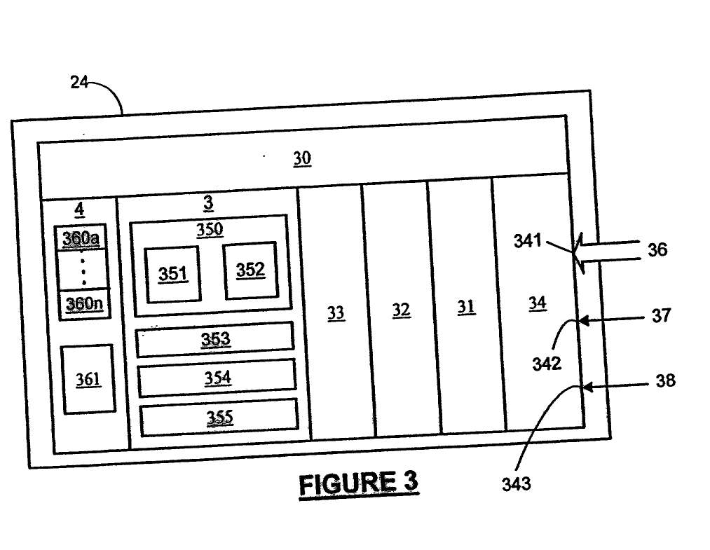

The trusted device 24 comprises a number of blocks, as illustrated in FIG. 3. After system reset, the trusted device 24 performs a secure boot process to ensure that the operating system of the platform 10 (including the system clock and the display on the monitor) is running properly and in a secure manner. During the secure boot process, the trusted device 24 acquires an integrity metric of the computing platform 10. The trusted device 24 can also perform secure data transfer and, for example, authentication between it and a smart card via encryption/decryption and signature/verification. The trusted device 24 can also securely enforce various security control policies, such as locking of the user interface.

Specifically, the trusted device comprises: a controller 30 programmed to control the overall operation of the trusted device 24, and interact with the other functions on the trusted device 24 and the other devices on the motherboard 20; a measurement function 31 for acquiring the integrity metric from the platform 10; a cryptographic function 32 for signing, encrypting or decrypting specified data; an authentication function 33 for authenticating a smart card; and interface circuitry 34 having appropriate ports (36, 37 & 38) for connecting the trusted device 24 respectively to the data bus 26, control lines 27 and address lines 28 of the motherboard 20. Each of the blocks in the trusted device 24 has access (typically via the controller 30) to appropriate volatile memory areas 4 and/or non-volatile memory areas 3 of the trusted device 24. Additionally, the trusted device 24 is designed, in a known manner, to be tamper-resistant.

For reasons of performance, the trusted device 24 may be implemented as an application specific integrated circuit (ASIC). However, for flexibility, the trusted device 24 is preferably an appropriately programmed micro-controller. Both ASICs and micro-controllers are well known in the art of microelectronics and will not be considered herein in any further detail.

One item of data stored in the non-volatile memory 3 of the trusted device 24 is a certificate 350. The certificate 350 contains at least a public key 351 of the trusted device 24 and an authenticated value 352 of the platform integrity metric measured by a trusted party (TP). The certificate is signed by the TP using the TP's private key prior to it being stored in the trusted device 24. In later communications sessions, a user of the platform 10 can verify the integrity of the platform 10 by comparing the acquired integrity metric with the authentic integrity metric 352. If there is a match, the user can be confident that the platform 10 has not been subverted. Knowledge of the TP's generally-available public key enables simple verification of the certificate 350. The non-volatile memory 3 also contains an identity (ID) label 353. The ID label is a conventional ID label, for example a serial number, that is unique within some context. The ID label 353 is generally used for indexing and labelling of data relevant to the trusted device 24, but is insufficient in itself to prove the identity of the platform 10 under trusted conditions.

The trusted device 24 is equipped with at least one method of reliably measuring or acquiring the integrity metric of the computing platform 10 with which it is associated. In this exemplary embodiment, the integrity metric is acquired by the measurement function 31 by generating a digest of the BIOS instructions in the BIOS memory. Such an acquired integrity metric, if verified as described above, gives a potential user of the platform 10 a high level of confidence that the platform 10 has not been subverted at a hardware, or BIOS program, level. Other known processes, for example virus checkers, will typically be in place to check that the operating system and application program code have not been subverted.

The measurement function 31 has access to: non-volatile memory 3 for storing a hash program 354 and a private key 355 of the trusted device 24, and volatile memory 4 for storing acquired integrity metric in the form of a digest 361. In appropriate embodiments, the volatile memory 4 may also be used to store the public keys and associated ID labels 360a-360n of one or more authentic smart cards 19 that can be used to gain access to the platform 10.

Exemplary processes for acquiring and verifying an integrity metric are described in detail in WO 00/48063.

Compartments will now be described further. The actions or privileges within a compartment are constrained, particularly to restrict the ability of a process to execute methods and operations which have effect outside the compartment, such as methods that request network access or access to files outside of the compartment. Also, operation of the process within the compartment is performed with a high level of isolation from interference and prying by outside influences.

Preferably, the compartment is an operating system compartment controlled by the operating system kernel. This is also referred to as a compartmented operating system or a trusted operating system.

Trusted operating systems have been available for several years in a form designed for handling and processing classified (military) information, using a containment mechanism enforced by a kernel of the operating system with mandatory access controls to resources of the computing platform such as files, processes and network connections. The operating system attaches labels to the resources and enforces a policy which governs the allowed interaction between these resources based on their label values. Most trusted operating systems apply a policy based on the Bell-Lapadula model discussed in the paper “Applying Military Grade Security to the Internet” by C I Dalton and J F Griffin published in Computer Networks and ISDN Systems 29 (1997) 1799-1808.

The preferred embodiment of the present invention adopts a simple and convenient form of operating system compartment. Each resource of the computing platform which it is desired to protect is given a label indicating the compartment to which that resource belongs. Mandatory access controls are performed by the kernel of the host operating system to ensure that resources from one compartment cannot interfere with resources from another compartment. Access controls can follow relatively simple rules, such as requiring an exact match of the label.

Examples of resources include data structures describing individual processes, share memory segments, semaphores, message queues, sockets, network packets, network interfaces and routing table entries.

Communication between compartments and network resources are provided via narrow kernel level controlled interfaces to a transport mechanism such as TCP/UDP. Access to these communication interfaces is governed by rules specified on a compartment by compartment basis. At appropriate points in the kernel, access control checks are performed such as through the use of hooks to a dynamically loadable security module that consults a table of rules indicating which compartments are allowed to access the resources of another compartment. In the absence of a rule explicitly allowing a cross compartment access to take place, an access attempt is denied by the kernel. The rules enforce mandatory segmentation across individual compartments, except for those compartments that have been explicitly allowed to access another compartment's resources.

Suitably, each compartment is allocated an individual section of a file system of the computing platform. For example, the section is a chroot of the main file system. Processes running within a particular compartment only have access to that section of the file system. Advantageously, through kernel controls, the process is restricted to the predetermined section of file system and cannot escape. In particular, access to the root of the file system is denied.

Advantageously, a compartment provides a high level of containment, whilst reducing implementation costs and changes required in order to implement an existing application within the compartment.

However, although a specific definition of a compartment is given above, this is intended as an example only, and other definitions of a compartment may be used. For example, the logically and/or physically protected computing environments described in the applicant's co-pending British Patent Application No. 0020441.2 entitled ‘Performance of a Service on a Computing Platform’, filed on Aug. 18, 2000, the contents of which are incorporated herein by reference.

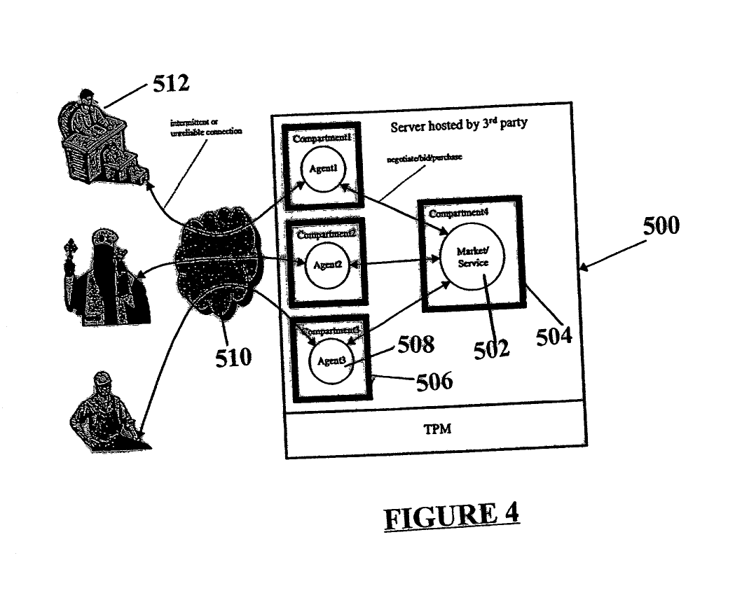

Referring to FIG. 4 of the drawings, there is illustrated schematically an exemplary embodiment of apparatus according to the present invention. As shown, the apparatus is hosted on a trusted computing platform or server 500 which runs a compartmented operating system. The electronic market or service 502 runs in a first logically protected computing environment or “compartment” 504. A plurality of other logically protected computing environments or “compartments” 506. Within each of the compartments 506 runs an autonomous client's agent or program 508 which can interact on behalf of a client 512 with the electronic market or service 502 even when the client is not connected to the network 510, or has an unreliable or slow connection thereto. Note that the client 512 is a computing device, which will usually be associated with a particular user.

Each agent 508 can access only its own data, i.e. only data held within its respective compartment 506. It cannot access the data of other agents or that of the electronic market or service 502. Similarly, each agent's private data is protected from access by other parties. This is achieved by the provision of very narrow and tightly-controlled communication interfaces between the agent compartments 506 and the market or service compartment 504. No communication interface is defined between the agent compartments 506 themselves. Thus, the only communication permitted in the apparatus of the present invention is that between a client 512 and their respective agent 508, and between an agent 508 and the electronic market or service 502. Neither other agents or outside parties can communicate or interfere with a client's agent, and the apparatus of the present invention provides a secure environment for remote agents to interact with an electronic service or market.

A trusted computing platform of the kind described here is a computing platform into which is incorporated a physical trusted device whose function is to bind the identity of the platform to reliably measured data that provides an integrity metric of the platform. The identity and the integrity metric are compared with expected values provided by a trusted party (TP) that is prepared to vouch for the trustworthiness of the platform. If there is a match, the implication is that at least part of the platform is operating correctly, depending on the scope of the integrity metric.

A client 512 can verify the correct operation of the host computing platform and allocated agent 508 before exchanging other data with the agent. A client 512 can do this by requesting the host computing platform to provide an integrity metric, which is then compared against a certificate issued by a trusted party that is prepared to vouch for the integrity of the host computing platform. A challenge and response may occur, such as the client 512 sending a random number sequence to the host computing platform and receiving the random number in return in an encoded format. If the verification is successful, the agent 508 is considered to be operating on a trusted ‘platform’, i.e the client 512 trusts the host computing platform because the client 512 trusts the trusted party. The trusted party trusts the host computing platform, because the trusted party has previously validated the identity and determined the proper integrity metric of the platform. Note that such a check can be used by the client before downloading an agent into such a compartment. Alternatively, such a check can be made by the agent itself once downloaded and before engaging in the market/service (in this case the agent may notify the client explicitly with the result by sending a message or else implicitly by only allowing the service provision to go ahead in the case that the agent is satisfied as to the response to the challenge). In either case, the market/service provision should not be entered into without the client and/or the agent checking that the response to this challenge satisfies the policy of the client. More detailed background information concerning an example method for verifying the computing platform and the host operating system is given in the above-mentioned co-pending application WO 00/48063 (Hewlett-Packard).

The status of the allocated agent compartment can also be verified. Compartment status verification suitably includes providing access to information about the compartment, or providing a status metric containing information in a specified form.

Particularly, status compartment verification includes at least one of (a) confirming identity of any open network connections; (b) confirming identity of any processes running in the compartment; and (c) confirming access to a valid section of file space. The information is provided in response to hooks (e.g. ioctls, syscalls) into the host operating system kernel, such as from user space. Preferably, authentication and authorisation checks are made to confirm that access to the compartment information is allowed. In general, only a valid user of a compartment might be returned integrity metrics corresponding to that compartment

Thus, a chain of trust is established firstly by verifying the host operating system, and then by verifying the allocated agent compartment of the host operating system.

There are a number of ways of achieving the intended effect. One way might be to provide agent software which verifies the trusted state of the platform and notifies the client 512 accordingly. In another arrangement, such agent software may be used as a conduit which allows the client 512 to verify trustworthiness itself.

Once the agent 508 has established trusted operation of the service 502 it exchanges other data with the service, interacting therewith, and the client 512 can then have greater confidence that data is being exchanged with an agent 508 and/or service 502 whose behaviour can be trusted.

In summary, the apparatus can prove to each party involved in the transaction/interaction that their agent and the market/service are operating in a trusted environment and were at the time of a completed transaction.

An embodiment of the present invention has been described above by way of example only, and it will be apparent to persons skilled in the art that modifications and variations can be made to the described embodiment without departing from the scope of the invention as defined by the appended claims.

1. Apparatus for enabling one or more clients to interact with an electronic service or market, the apparatus comprising a computing platform including a first logically protected computing environment within which said electronic service or market is run, and one or more second logically protected computing environment, within which or each of which is provided agent means for interacting with said electronic service or market on behalf of a respective client.

2. Apparatus according to claim 1, wherein communication interfaces are defined only between said agent means and a respective client, and between said agent means and said electronic market or service.

3. Apparatus according to claim 1, comprising means to verify to a client involved in a transaction or interaction with said electronic market or service that the respective agent means and the electronic market or service are operating in a trusted environment, before, during and/or after a transaction takes place.

4. A method of enabling one or more clients to interact with an electronic service or market, the method comprising the steps of providing a computing platform including a first logically protected computing environment and one or more second logically protected computing environments, running said electronic service or market in said first logically protected computing environment, and running within the or each second logically protected computing environment, agent means for interacting with said electronic service or market on behalf of a respective client.

5. A method according to claim 4, further comprising the step of verifying, in response to a request or otherwise, to a client involved in a transaction or interaction with said electronic market or service that the respective agent means and the electronic market or service are operating in a trusted environment, before, during and/or after a transaction takes place.

6. A method according to claim 4, wherein communication interfaces are defined only between said agent means and a respective client, and between agent means and said electronic market or service.

7. A computing platform programmed to support an electronic service, comprising:
a first logically protected computing environment within which the electronic service runs; and
two or more second logically protected computing environments each adapted to contain user agents;
wherein the computing platform provides communication paths between the first logically protected computing environment and each of the two or more second logically protected computing environments, but does not provide communication paths between the two or more second logically protected computing environments.

8. A computing platform as claimed in claim 7, wherein the electronic service is a market.

9. A computing platform as claimed in claim 7, wherein the computing platform runs a compartmented operating system, and wherein the first logically protected computing environment and the two or more second logically protected computing environments are compartments.

10. A computing platform as claimed in claim 7, wherein the computing platform is adapted to provide a measure of the integrity of the computing platform on request.

11. A data carrier carrying a code structure to act as a user agent interacting with an electronic service running in a first logically protected computing environment of a computing platform, wherein the code structure is adapted to be installed on a second logically protected computing environment of the computing platform: the code structure being adapted to communicate with a user to receive instructions and to provide information about the electronic service, being adapted to communicate with the electronic service in the first logically protected computing environment to interact with the electronic service on behalf of the user.

12. A data carrier as claimed in claim 11, wherein the code structure is further adapted to verify integrity of a second logically protected computing environment in which it is installed.

13. A data carrier as claimed in claim 11, wherein the code structure is further adapted to verify integrity of a computing platform containing a second logically protected computing environment in which it is installed.
